(19) United States
(12) Patent Application Publication
(10) Pub. No.: US 2016/0191865 A1
(43) Pub. Date: Jun. 30, 2016

(54) SYSTEM AND METHOD FOR ESTIMATING AN EXPECTED WAITING TIME FOR A PERSON ENTERING A QUEUE

(71) Applicant: NICE-SYSTEMS LTD., Ra'anana (IL)

(72) Inventors: Marina BEISER, Kiryat Yam (IL); Daphna Idelson, Tel Aviv (IL); Doron Girmonski, Ra'anana (IL)

(21) Appl. No.: 14/585,409

(22) Filed: Dec. 30, 2014

(51) Int. Cl. H04N 7/18; G06K 9/00

(52) U.S. Cl. CPC H04N 7/188; G06K 9/00221; H04N 7/183

(57) ABSTRACT

A system and method for estimating an expected waiting time for a person entering a queue may receive image data captured from at least one image capture device during a period of time prior to the person entering the queue; calculate, based on the image data, one or more prior waiting time estimations, a queue handling time estimation, and a queue occupancy; assign a module weight to each of the one or more prior waiting time estimations and to the queue handling time estimation; generate, based on at least the calculations of the one or more prior waiting time estimations, the queue handling time estimation, and the respective module weights, a recent average handling time for the prior period of time; and determine the expected waiting time based on the recent average handling time and the queue occupancy.

### FIELD OF THE INVENTION

The present invention is in the field of video surveillance. In particular, the present invention is directed to estimating a waiting time in a queue based on video surveillance.

### BACKGROUND OF THE INVENTION

Queue management is more in demand in locations where managing large numbers of people is critical for safety and efficiency, such as in airports, stadiums, and retail centers. An essential part of queue management is estimating how long an individual will spend waiting in a queue. Such information may be useful for accumulating statistics, generating relevant alerts, providing information for arriving individuals to a queue, or as information for working personnel to allocate resources and thus to reduce queuing time.

Video surveillance is known to be used for queue management. For example, suspect search systems that identify, track and/or monitor an individual use video surveillance or video monitoring, and may be repurposed for tracking an individual in a queue. Video Content Analysis (VCA) or video analytics are known and used, e.g., for automatic analysis of a video stream to detect or identify points of interest. Video analytics is becoming more prevalent in a wide range of domains such as security, entertainment, healthcare, surveillance, and now queue and crowd management.

However, known systems for queue management, and particularly waiting time estimation, suffer from a number of drawbacks. Known systems may use search algorithms or methods that may work well when provided with input from a single camera's field of view (FOV), but are unable to process multiple FOV's input. Other methods may process multiple FOVs, but assume clear overlaps between the FOVs, which, for most real-world scenarios, is not the case. Other known systems and methods are based on tracking, which is prone to fail in densely populated areas. Yet other systems and methods may fail when input images are acquired in varying conditions, e.g., a change in lighting, indoor/outdoor, angles, different cameras' settings, etc.

Furthermore, some systems which measure the time individuals spend in a queue require detecting and tracking all individuals through the entire queue, which may drain resources. Furthermore, some systems require tracking to be accomplished utilizing stereo vision technology, which is often not available, and may be expensive to install in large areas.

Some systems employed for waiting time estimation rely on tracking smartphones and other mobile devices on the person being tracked in a queue. Such systems require location sensing and WiFi sensing to determine the time a person has waited in the queue based on the location of the device. Finally, some systems rely on the dependency between the waiting time and the time of the day at which the time was measured.

### SUMMARY OF EMBODIMENTS OF THE INVENTION

An embodiment of the invention includes a method for estimating an expected waiting time for a person entering a queue. Embodiments of the method may be performed on a computer having a processor, memory, and one or more code modules stored in the memory and executing in the processor. Embodiments of the method may include such steps as receiving, at the processor, image data captured from at least one image capture device during a period of time prior to the person entering the queue; calculating, by the processor, based on the image data, one or more prior waiting time estimations, a queue handling time estimation, and a queue occupancy; wherein a prior waiting time estimation is an estimation of the time a prior outgoer of the queue waited in the queue; and wherein a queue handling time estimation is an estimation of an average handling time for an outgoer of the queue; assigning, by the processor, a module weight to each of the one or more prior waiting time estimations and to the queue handling time estimation; generating, by the processor, based on at least the calculations of the one or more prior waiting time estimations, the queue handling time estimation, and the respective module weights, a recent average handling time for the prior period of time; and determining, by the processor, the expected waiting time based on the recent average handling time and the queue occupancy.

In some embodiments, the method may further include generating, by the processor, for each prior waiting time estimation, an associated confidence score. In some embodiments, calculating the one or more prior waiting time estimations may further include identifying, by the processor, based on the image data, one or more incomers as the one or more incomers enter the queue, and one or more outgoers as the one or more outgoers exit the queue; generating, by the processor, for each identified incomer, a unique entrance signature and an entrance time stamp, and for each identified outgoer, a unique exit signature and an exit time stamp; comparing, by the processor, one or more unique exit signatures with one or more unique entrance signatures; and based on the signature comparing step, outputting, by the processor, a prior waiting time estimation, wherein the prior waiting time estimation represents a difference between the entrance time stamp of the compared unique entrance signature and the exit time stamp of the compared unique exit signature.

In some embodiments of the method, each signature comparison may be assigned a similarity score representing a likelihood of the one or more compared unique exit signatures and the one or more compared unique entrance signatures having each been generated from the same person; and outputting the prior waiting time estimation may be based on a highest assigned similarity score among a plurality of signature comparisons.

In some embodiments of the method, calculating the one or more prior waiting time estimations may include identifying, by the processor, based on the image data, one or more entering unique segments relating to a plurality of incomers as the plurality of incomers enter the queue, and one or more progressing unique segments relating to a plurality of progressing people as the plurality of progressing people progress along the queue; generating, by the processor, for each identified entering unique segment, a unique entrance signature and an entrance time stamp, and for each identified progressing unique segment, a unique progress signature and a progress time stamp; comparing, by the processor, one or more unique entrance signatures with one or more unique progress signatures; and based on the signature comparing step, outputting, by the processor, a prior waiting time estimation, wherein the prior waiting time estimation represents a difference between the entrance time stamp of the compared unique entrance signature and the exit time stamp of the compared unique exit signature as a function of a length of the queue.

In some embodiments of the method, each signature comparison may be assigned a similarity score representing a likelihood of the one or more compared unique entrance signatures and the one or more compared unique progress signatures having each been generated from the one or more people; and outputting the prior waiting time estimation may be based on a highest assigned similarity score among a plurality of signature comparisons.

In some embodiments, the handling time estimation may include a difference in time between a first identified outgoer of the queue and a second identified outgoer of the queue, as a function of a number of available queue handling points at an exit of the queue. In some embodiments, a module weight may be assigned to each of the one or more prior waiting time estimations and to the handling time estimation based on a historical module accuracy for a previous period of time.

In some embodiments of the method, generating the recent average handling time may further include assigning a decay weight to one or more of the one or more prior waiting time estimations, the queue handling time estimation, and the queue occupancy, based on a decaying time scale, wherein recent calculations are assigned lower decay weights and older-in-time calculations are assigned higher decay weights. In some embodiments, queue occupancy may include at least one of an approximation of a number of people in the queue and an actual number of people in the queue.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 is an example of a typical queue according to at least one embodiment of the invention;

FIG. 2 is a high level diagram illustrating an example configuration of a system for estimating an expected waiting time according to at least one embodiment of the invention;

FIG. 3 is a general block diagram of the main components of the system of FIG. 2 according to at least one embodiment of the invention;

FIG. 4 is a flow diagram of a method of implementing a person identifier module according to at least one embodiment of the invention;

FIG. 5 is a flow diagram of a method of implementing a unique color and/or texture tracking module according to at least one embodiment of the invention;

FIG. 6A is an example of a back-end area of a queue according to at least one embodiments of the invention;

FIG. 6B is an example of background subtraction according to at least one embodiment of the invention;

FIG. 6C is an example of foreground objection joining according to at least one embodiment of the invention;

FIG. 6D is an example of a defined color description for a segment according to at least one embodiment of the invention; and

FIG. 7 is a flow diagram of a method of implementing a person count module according to at least one embodiment of the invention.

It will be appreciated that for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF EMBODIMENTS OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory processor-readable storage medium that may store instructions, which when executed by the processor, cause the processor to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof may occur or be performed simultaneously, at the same point in time, or concurrently.

Embodiments of the invention estimate the expected waiting time (e.g., represented in minutes, seconds, hours, etc.) in a queue (e.g., a line of people waiting, or another assembly of people waiting) by combining the outputs of one or more of several modules, each of which are described in detail herein: one or more person identifier modules (for example, facial recognition, object signature recognition, etc.), a unique color and texture tracking module, and a queue occupancy module (e.g., a people counter). In some embodiments, the outputs of all the modules are combined to produce a higher accuracy estimation. As understood herein, the expected waiting time is an estimation of the time a person entering a queue (e.g., an “incomer” to the queue) at the queue entrance can expect to wait in the queue, and progress through the queue from entrance to exit, before exiting the queue (e.g., an “outgoer” from the queue) at the queue exit. While modules are described herein, methods according to embodiments of the present invention may be carried out without distinct partitions among modules or modules as described.

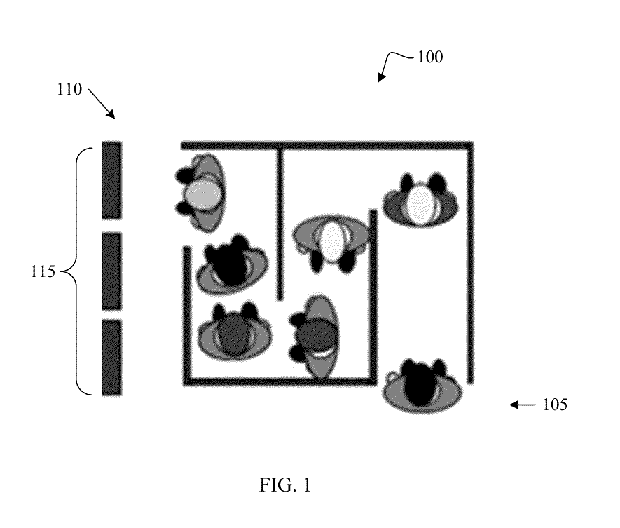

FIG. 1 shows an example of a typical queue 100 in accordance with embodiments of the invention. The queue includes a queue entrance 105, a queue exit 110, and one or more queue handling points 115. In typical fashion, people enter the queue (e.g., “get on line”) at queue entrance 105, and exit the queue at queue exit 110. It will of course be appreciated that queue 100 may take many forms depending on the location of the queue and the configuration of the queue boundaries. For example, a queue may bend and turn (as show in the example queue 100), may have one or more curves, may be a straight line, etc. The queue may be a single-file queue or may accommodate a number of people traveling in parallel through the queue. Furthermore, depending on implementation and circumstances, there may or may not be actual physical boundaries defining a designated queue area. For example, in some embodiments, a queue area may be a physically enclosed (e.g., bounded) area where only waiting people may be present, while in some embodiments a queue area may not be physically enclosed but may likewise be only occupied by people waiting the queue. Furthermore, in some embodiments a boundary or barrier may be a physical boundary (e.g., railings, ropes, painted lines, cones, dividers, partitions, etc.) or may be in the form of a space or gap where the only people allowed on one side of the space or gap are those who are associated with the queue.

In accordance with some embodiments of the invention, a defined queue entrance (e.g., one or more points defined as a queue entrance), and a defined queue exit (e.g., one or more points defined as a queue exit), in which people enter the queue at queue entrance 105, progress through the queue, and exit the queue at queue exit 110, may suffice for operation of embodiments of the invention.

In various embodiments, queue handling point 115 may be located at or proximate to queue exit 110, and may be, for example, a cashier, register, ticket booth, entrance, security checkpoint, help desk, a threshold, a destination, or any other terminal, terminal point, or terminal points at which an incomer to queue 100 is expected to reach via the queue. As such, in some embodiments, queue handling point 115 may be equivalent to queue exit 110, for example, when there is only one queue handling point, and the queue handling point does not require a person exiting the queue to stop at queue exit 110 (e.g., there is no handling time associated with handling point 115). In some embodiments, there may be multiple handling points 115 at the end of queue 100, some of which may be available or unavailable for use, etc., such as, for example, a supermarket payment queue having multiple cashiers to service one queue, in which people exiting the queue at queue exit 110 are serviced by the next available cashier.

In some embodiments, each terminal (e.g., queue handling point 115) may have an associated terminal handling time representing the average time it takes for a person to be serviced upon reaching a handling point 115. For example, a terminal handling time for a cashier may be a period of time from the moment a first customer reaches the cashier until the moment the cashier completes a transaction and the first customer exits the queue, thus allowing a second customer to reach the cashier. By way of another example, a terminal handling time may be a period of time from the moment a first ticketholder reaches a ticket collector at the end of a ticket queue, until the moment a second ticketholder reaches the ticket collector. Furthermore, in some embodiments, each queue may have an associated queue handling time estimation representing the average handling time for the queue, based, for example, on the number of available terminals at the exit of the queue. As such, the queue handling time estimation may represent a difference in time between a first identified outgoer of the queue and a second identified outgoer of the queue, as a function of a number of available queue handling points at an exit of the queue. Queue handling time may be calculated, for example, by dividing the terminal handling time by the number of handling points 115 servicing queue 100. As described herein, terminal handling time and queue handling time influence the expected waiting time estimation for future incomers to the queue.

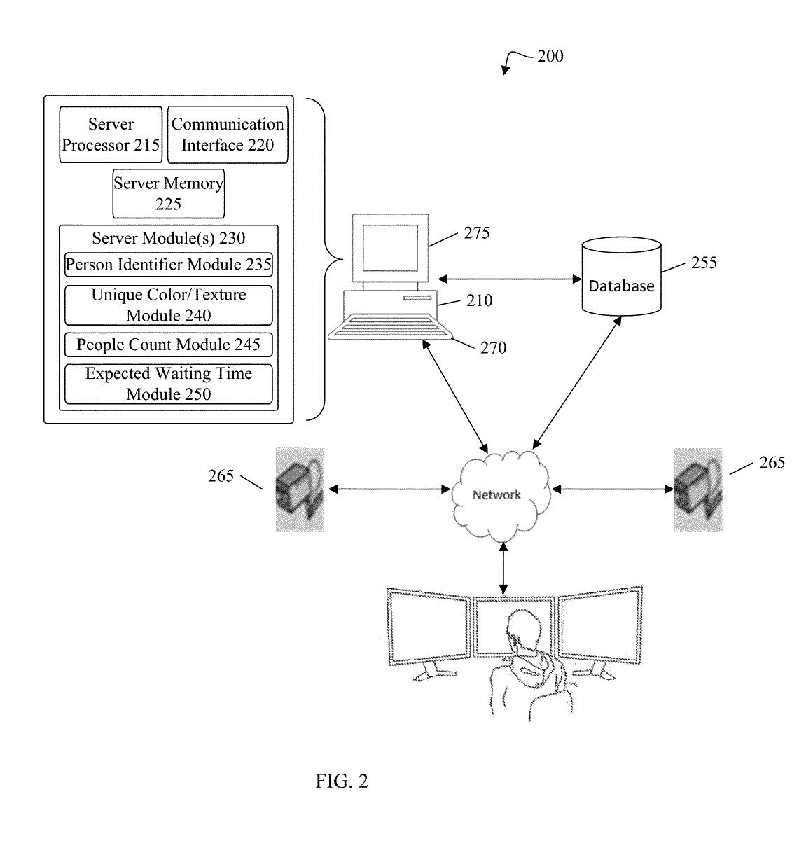

FIG. 2 shows a high level diagram illustrating an example configuration of a system 200 for estimating an expected waiting time according to at least one embodiment of the invention. System 200 includes network 205, which may include the Internet, one or more telephony networks, one or more network segments including local area networks (LAN) and wide area networks (WAN), one or more wireless networks, or a combination thereof. System 200 also includes a system server 210 constructed in accordance with one or more embodiments of the invention. In some embodiments, system server 210 may be a stand-alone computer system. In other embodiments, system server 210 may communicate over network 205 with multiple other processing machines such as computers, and more specifically, stationary devices, mobile devices, terminals, and/or computer servers (collectively, “computing devices”). Communication with these computing devices may be either direct or indirect through further machines that are accessible to the network 205.

System server 210 may be any suitable computing device and/or data processing apparatus capable of communicating with computing devices, other remote devices or computing networks, receiving, transmitting and storing electronic information and processing requests as further described herein. System server 210 is therefore intended to represent various forms of digital computers, such as laptops, desktops, workstations, personal digital assistants, servers, blade servers, mainframes, and other appropriate computers and/or networked or cloud based computing systems capable of employing the systems and methods described herein.

System server 210 may include a server processor 215 which is operatively connected to various hardware and software components that serve to enable operation of the system 200. Server processor 215 serves to execute instructions to perform various operations relating to video processing and other functions of embodiments of the invention as will be described in greater detail below. Server processor 215 may be one or a number of processors, a central processing unit (CPU), a graphics processing unit (GPU), a multi-processor core, or any other type of processor, depending on the particular implementation. System server 210 may be configured to communicate via communication interface 220 with various other devices connected to network 105. For example, communication interface 220 may include but is not limited to, a modem, a Network Interface Card (NIC), an integrated network interface, a radio frequency transmitter/receiver (e.g., Bluetooth wireless connection, cellular, Near-Field Communication (NFC) protocol, a satellite communication transmitter/receiver, an infrared port, a USB connection, and/or any other such interfaces for connecting the system server 210 to other computing devices, sensors, image capture devices (e.g., video and/or photographic cameras), and/or communication networks such as private networks and the Internet.

In certain implementations, a server memory 225 is accessible by server processor 215, thereby enabling server processor 215 to receive and execute instructions such a code, stored in the memory and/or storage in the form of one or more software modules 230, each module representing one or more code sets. The software modules 230 may include one or more software programs or applications (collectively referred to as the “server application”) having computer program code or a set of instructions executed partially or entirely in the processor 215 for carrying out operations for aspects of the systems and methods disclosed herein, and may be written in any combination of one or more programming languages. Processor 215 may be configured to carry out embodiments of the present invention by for example executing code or software, and may be or may execute the functionality of the modules as described herein.

As shown in FIG. 1, the exemplary software modules may include a person identifier module 235, a unique color and/or texture tracking module 240 (hereinafter “UCT tracking module”), a people count module 245, and an expected waiting time module 250. It should be noted that in accordance with various embodiments of the invention, server modules 230 may be executed entirely on system server 210 as a stand-alone software package, partly on system server 210 and partly on monitoring terminal 260, or entirely on monitoring terminal 260.

Server memory 225 may be, for example, a random access memory (RAM) or any other suitable volatile or non-volatile computer readable storage medium. Server memory 225 may also include storage which may take various forms, depending on the particular implementation. For example, the storage may contain one or more components or devices such as a hard drive, a flash memory, a rewritable optical disk, a rewritable magnetic tape, or some combination of the above. In addition, the memory and/or storage may be fixed or removable. In addition, memory and/or storage may be local to the system server 210 or located remotely.

In accordance with further embodiments of the invention, system server 210 may be connected to one or more database(s) 255, either directly or remotely via network 205. Database 255 may include any of the memory configurations as described above, and may be in direct or indirect communication with system server 210. Database 255 may be a database belonging to another system, such as an image database, etc.

As described herein, among the computing devices on or connected to the network 205 may be user devices which may include monitoring terminal 260. Monitoring terminal 260 may be any standard computing device. As understood herein, in accordance with one or more embodiments, a computing device may be a stationary computing device, such as a desktop computer, kiosk and/or other machine, each of which generally has one or more processors configured to execute code to implement a variety of functions, a computer-readable memory, one or more input devices, one or more output devices, and a communication port for connecting to the network 205. Typical input devices, such as, for example, input device 270, may include a keyboard, pointing device (e.g., mouse or digitized stylus), a web-camera, and/or a touch-sensitive display, etc. Typical output devices, such as, for example output device 275 may include one or more of a monitor, display, speaker, printer, etc.

Additionally or alternatively, a computing device may be a mobile electronic device (“MED”), which is generally understood in the art as having hardware components as in the stationary device described above, and being capable of embodying the systems and/or methods described herein, but which may further include componentry such as wireless communications circuitry, gyroscopes, inertia detection circuits, geolocation circuitry, touch sensitivity, among other sensors. Non-limiting examples of typical MEDs are smartphones, personal digital assistants, tablet computers, and the like, which may communicate over cellular and/or Wi-Fi networks or using a Bluetooth or other communication protocol. Typical input devices associated with conventional MEDs include, keyboards, microphones, accelerometers, touch screens, light meters, digital cameras, and the input jacks that enable attachment of further devices, etc.

In some embodiments, monitoring terminal 260 may be a “dummy” terminal, by which image processing and computing may be performed on system server 210, and information may then be provided to monitoring terminal 260 via communication interface 220 for display and/or basic data manipulation.

System 200 may include one or more image capture devices 265. In some embodiments, image capture device 265 may be any input camera sensor, such as a video camera, a digital still image camera, a stereo vision camera, etc. In some embodiments, image capture device 265 may be, for example, a digital camera, such as an internet protocol (IP) camera, or an analog camera, such as a Closed Circuit Television (CCTV) surveillance camera. In some embodiments, image capture device 265 may be a thermal detection device. In some embodiments, image capture device 265 may be a color capture device, which in other embodiments a “black and white” or grayscale capture device may be sufficient. In some embodiments, image capture device 265 may be a thermal imaging device or any other device suitable for image capture. Image capture device 265 may stream video to system 200 via network 205. For example, image capture device 265 may continuously or periodically capture and stream image data such as, for example, video or still images (collectively “images”) from a location or area, e.g., an airport terminal. In some embodiments, image data may include, for example, a digital representation of images captured and/or related metadata, such as, for example, related time stamps, location information, pixel size, etc. Multiple image capture devices 265 may receive input (e.g. image data) from an area, and the FOV from the devices may overlap or may not. In some embodiments, input from image capture devices 265 may be recorded and processed along with image metadata.

In some embodiments, queue 100 may be monitored entirely by one image capture device 265, while in some embodiments, multiple image capture devices 265 may be required. For example, in some embodiments, one image capture device 265 may capture images of people entering queue 100 at queue entrance 105, while another image capture device 265 may capture images of people exiting queue 100 at queue exit 110. Furthermore, one or more image capture devices 265 may capture images along queue 100. In some embodiments, input from the one or more image capture devices 265 may first be stored locally on internal memory, or may be streamed and saved directly to external memory such as, for example, database 255 for processing.

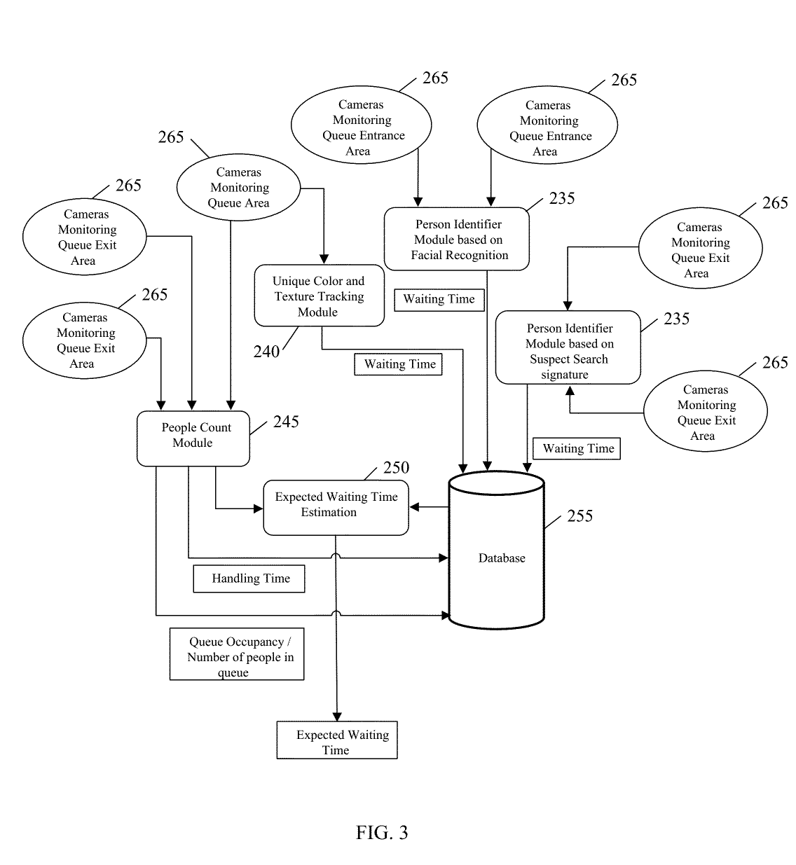

FIG. 3 shows a general block diagram of the main components of system 200 according to at least one embodiment of the invention. A detailed description of each component is provided herein. As depicted in FIG. 3, rectangles with rounded corners represent system components (e.g., server modules 230). The ovals represent input from input camera sensors, such as image capture device 265. Rectangles with squared corners represent one or more outputs of the system components in accordance with various embodiments of the invention.

In accordance with embodiments of the inventions, one or more person identifier modules 235 and/or UCT tracking module 240 may be implemented for estimating a prior waiting time estimation in queue 100. As understood herein, the prior waiting time estimation may be an estimation of the time a recent or other outgoer of the queue (e.g., a prior outgoer) waited in the queue prior to exiting. It should be noted that while in some embodiments the prior waiting time estimation may be the actual period of time required for a prior outgoer (e.g., a recent outgoer or the most recent outgoer) from the queue to progress through the queue from the queue entrance to the queue exit, in other embodiments the prior waiting time estimation may be an approximation and/or an averaged based on one or more recent or other outgoers (e.g., prior outgoers) from the queue. Furthermore, the prior waiting time estimation may be, for example, an estimation of the time the last person to exit the queue took to progress through the entire queue. In some embodiments, a prior period of time during which the prior waiting time estimation may be calculated may typically include a predefined period of time leading up to the moment a person enters the queue.

The people count module 245 may be used for estimating the number of people in the queue as well as the queue handling time. These values may be stored for example in a database allowing calculating the expected waiting time by expected waiting time estimation module 250. In accordance with embodiments of the invention, system 200 may be composed of the following sub systems (other or different subsystems or modules may be used).

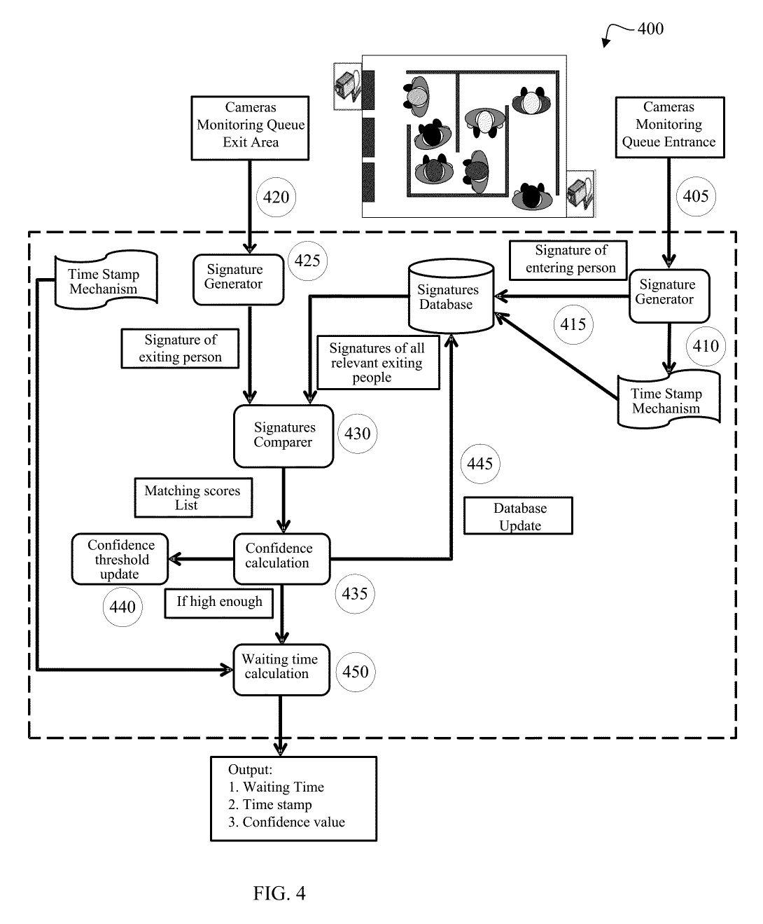

Person Identifier Module 235 (described in further detail in the description of FIG. 4) may receive input from a first image capture device 265 monitoring queue entrance 105 and a second image capture device monitoring queue exit 110. Person Identifier Module 235 may then output a prior waiting time estimation, which may be calculated as the time difference for the same person between the times the person is identified at the exit and the entrance of the queue. The output may be stored in for example database 255. As described in detail herein, the person may be automatically recognized using identification technologies such as, for example, face recognition technology, suspect search signature technology, etc. Furthermore, several person identifier modules may be combined, each one employing a different recognition technology. In FIG. 3, for example, two such person identifier modules are shown being implemented, one based on face recognition and the other based on an object's signature as presented in U.S. Patent Publication No. 2014-0328512 (U.S. patent application Ser. No. 14/109,995, entitled “System and Method for Suspect Search”, hereinafter the “Suspect Search application”), which is hereby incorporated by reference in its entirety.

Facial recognition technology typically extracts unique details of person's facial structure to create a unique facial signature, which may be compared against a database of other facial signatures. Typically, for facial recognition technology to be affective, in some embodiments, image capture devices may need to be positioned such that a face of a person walking and looking approximately straight forward will be of nearly frontal posture and of a required resolution. In a Suspect Search system, a signature may include at least two main parts: color features and texture features. The signature may be based on complete object appearance in which a complete object may be differentiated from other objects in the scene. For identifying people, the signature may be based on full body appearance (e.g., colors and textures). The system may capture insightful information about the object appearance, and can differentiate it from other objects in the scene. The signature may be inherently invariant to many possible variations of the object, such as rotation and scaling, different indoor/outdoor lighting, and different angles and deformations of an object's appearances. In some embodiments, the signature may be composed of a set of covariance matrices representing key point segments which are relatively large segments of similar color-texture patches.

For Suspect Search technology, the signature may be compared to other signatures using a unique similarity measurement which is designed specifically for this signature. A detailed description of the similarity measurement appears in the referenced Suspect Search application; however, a brief description is provided herein. In some embodiments, the more similar two objects' appearance is, the higher the score that will generated by the similarity measurement. The key points of one object's signature may be compared against the key points of another object's signature. The subset of pairwise key points combinations from both signatures that maximizes the similarity function is chosen. Mathematically, as the key points are represented by covariance matrices, in some embodiments the similarity function may include a measure for the geodesic distance between two covariance matrices, which is then formulated into a probability using the exponential family.

Unique color and/or texture tracking technology typically extracts unique details of one or more people whose appearance (e.g., hair color, skin color, clothing color, clothing material, apparel, etc.) create a unique color and/or texture signature, which may be compared against a database of other color and/or texture signatures. Unique color and/or texture tracking module 240 (described in further detail in the description of FIG. 4 through FIG. 7) may receive input from one or more image capture devices 265 monitoring the area along queue 100 from queue entrance 105 to queue exit 110. UCT tracking module 240 may then output a prior waiting time estimation based on tracking unique color and/or texture signatures, detected in the image data from people progressing through queue 100. The output may be stored in database 255. Data discussed herein as being stored in a database may in some embodiments be handled differently; e.g., the data may be passed directly to another module or process.

People count module 245 (described in further detail in the description of FIG. 8) may receive input from one or more image capture devices 265 monitoring queue entrance 105, queue exit 110, and/or the area along queue 100 from queue entrance 105 to queue exit 110. People count module 245 may then output one or more of the queue occupancy (e.g., an estimation of the number of people in queue and/or an actual number of people in the queue) and a queue handling time, which may be stored in database 255.

It should be noted that the type and/or location of each image capture device 265 required for each module may be different. For example, the image capture devices 265 used for people count at queue entrance 105 may differ from the image capture device 265 used for face recognition.

Expected waiting time estimation module 250 may calculate an expected waiting time estimation based on the following values retrieved from database 255: one or more of the prior waiting time estimations, the queue handling time, and the queue occupancy. The expected waiting time estimation is discussed in detail herein; however descriptions of the various components which generate the outputs necessary for calculating the expected waiting time estimation are first discussed in the descriptions of FIGS. 4 through 7.

FIG. 4 shows a flow diagram of a method 400 of implementing person identifier module 235 according to at least one embodiment of the invention. In some embodiments, person identifier module 235 may utilize components from existing technologies implemented for person identification. An implementation of these technologies enables person identifier module 235 to identify people exiting the queue (outgoers) and compare them against the people who have been identified entering the queue (incomers) to find a match. Based on this matching, the prior waiting time may be estimated.

In some embodiments, there need not necessarily be any assumption regarding the queue structure. Accordingly, the only requirement may be to have clear exit and entrance areas where images of person may be captured according to the specifications of the implemented identification technology. As such, in some embodiments, any appearance-based identification technology that is enabled to provide at least the following components may be utilized.

Signature generator—a unit that receives a video stream or images as an input, and outputs a unique descriptor (e.g., a signature) of the person, detected in the image, in the form of metadata that may be stored in a database.

Signatures comparer—a unit that receives two signatures and outputs a similarity score, which in some embodiments is a gauge of how closely the two signatures match one another. The similarity score typically represents the likelihood of each of the signatures having been generated from the same person. This can be expressed, for example, as a percentage or other numerical indicator.

In identification systems, the signature is a set of features that are intended to present a human (for example, a human face in facial recognition systems) in a unique manner. The chosen features vary among different methods/technologies. The signature is calculated from one or several images. In the process of enrollment (signature generation), the signature may be stored in a database. When identifying (signature matching) a person against the database, the person's signature is compared to all signatures stored in the database, yielding a matching similarity score. The higher the score, the higher the likelihood that the same person created both signatures. The similarity score may represent a likelihood of one or more compared unique exit signatures and one or more compared unique entrance signatures having each been generated from the same person. An outputted prior waiting time estimation may therefore be based on a highest assigned similarity score among a plurality of signature comparisons, as explained herein.

Therefore, embodiments of the invention implement these technologies at queue entrances and exits for extracting the prior waiting time. The image capture devices that monitor the queue entrance and exit are used to acquire the images needed for the initial identification (enrollment) and later identification respectively. In the enrollment process, signatures are stored along with the relevant time stamps and/or other metadata. Since the enrollment and later identification typically occur at relatively close time intervals, recognition performance may be enhanced since people who have enrolled do not change their appearance while in the queue. Furthermore, illumination conditions are likely to be very similar during both initial identification (e.g., enrollment of incomers at queue entrance 105) and later identification (e.g., of outgoers at queue exit 110). In addition, the number of signatures in the database is in the same order of magnitude as the number of people waiting in the queue, which may make identification more efficient.

In some embodiments, there may be several person identifier modules in system 200, each one utilizing a different identification technology. Each technology may also require a different configuration of image capture devices and/or different types of image capture devices. As such, in some embodiments, depending on the circumstances, a person identifier module based on one technology may provide more accuracy than a person identifier module based on another technology, and therefore may be more appropriate. For example, there may be instances where security infrastructure (e.g., video surveillance cameras, queue borders, etc.) has already been installed and/or cannot be augmented or supplemented for a particular queue, and the infrastructure may lend itself to one type of technology over another. Therefore, while more than one person identifier module 235 may be implemented, in some embodiments the outputs from each person identifier module 235 may be assigned or associated with a module weight (described in further detail herein) based, for example, on some measure of historical accuracy.

In some embodiments, method 400 begins at step 405, when an image capture device 265 monitoring queue entrance 105 streams image content (e.g., video) of incomers to queue 100 to system server 210 in conventional manner. In some embodiments, the processor is configured to identify, based on the image data, one or more incomers as the one or more incomers enter the queue, and one or more outgoers as the one or more outgoers exit the queue. To accomplish this, at steps 410 and 415, system server 210, using server processor 215, which is configured by executing one or more software modules 230, including, for example, person identifier module 235, may generate a unique entrance signature for an incomer to queue 100 (step 410), and stores the unique entrance signature in database 255 along with its time stamp (step 415). For example, a captured image which includes the face of an incomer to the queue can be processed using, for example, facial recognition technology, as described herein, to generate a unique signature of an incomer entering the queue based on unique features of the incomer's face. A time stamp for each new signature generated indicating, for example, a time and/or date of entry into the queue can be retrieved from the image metadata and/or determined based on any conventional time tracking apparatus, and stored in conjunction with the unique entrance signature. In some embodiments, as more people enter the queue, this enrollment process is repeated.

Likewise, at step 420, an image capture device 265 monitoring queue exit 110 streams image content (e.g., video) of people exiting queue 100 to system server 210 in conventional manner. At step 425, server processor 215, executing person identifier module 235, is configured to generate a unique exit signature for a person exiting queue 100 at queue exit 110. At step 430, server processor 215 is configured to compare the signature of the exiting person against one or more signatures previously stored in database 255, resulting in one or more matching score being assigned. These matching scores may be saved in a matching score list reflecting all the comparisons which have been performed over a given period of time. By saving all matching scores to a matching score list, higher matching scores may be quickly identified by system server 210.

Next, as step 435, server processor 215, executing person identifier module 235, is configured to calculate a confidence score (e.g., a coefficient or other value) for the highest matching score in the matching score list. In some embodiments, the confidence score may be a representation of the confidence in the accuracy of the results of the signature comparisons. In some embodiments, all that is required by the system is to estimate the average prior waiting time, and not necessarily the prior waiting time for each exiting person. Therefore, in some embodiments, a prior waiting time may be outputted only for comparisons with high similarity (matching) scores and with high confidence scores.

The confidence score or coefficient Cᵢ may be defined for example as follows:

$${C}_{i} = \frac{{S}_{im}}{{A}_{im}}$$

$${A}_{iM} = \frac{1}{N - 1} {\sum }_{j = 1 , j \neq m}^{N} {S}_{ij}$$

Where Sᵢₘ represents the maximal (highest) similarity score from the list of scores and A_{iM} represents the average of all other similarity scores. (Formulas described herein are intended as examples only and other or different formulas may be used.) As such, high confidence may be achieved when there is a high similarity score and it is significantly higher relative to other scores. It will of course be understood that in some embodiments, an average of a plurality of highest matching scores (e.g., matching scores above a defined threshold) may alternatively be used, rather than only using the highest similarity score in the matching score list. The prior waiting time may be outputted, for example, only if the confidence score Cᵢ and/or the maximal matching score S_{iM} are higher than a confidence threshold and a matching score threshold, respectively, which may be updated constantly.

At step 440, once a prior waiting time has been outputted (e.g., confidence score Cᵢ and/or the maximal matching score S_{iM} are higher than their respective defined thresholds), server processor 215, executing person identifier module 235, is configured to update the confidence threshold. Then, at step 445, database 255 may be updated. In some embodiments, when the confidence score is sufficiently high as to affect an update, the relevant signature records may be deleted from database 255, as they have been accounted for. In addition, all records may be deleted after some defined period of time as the likelihood of their relevance decreases over time (e.g., as more people exit and enter the queue).

Finally, at step 450, server processor 215, executing person identifier module 235, is configured to calculate the prior waiting time, which represents the difference in the relevant time stamps. The outputs, in this embodiment, of person identifier module 230 are the following:

The prior waiting time estimation Wₜ of a person that entered the queue at time t and exited at time Wₜ+t;

The corresponding time stamp t; and

The confidence score Cₜ for the relevant identification matching score. (It should be noted that Cₜ is essentially equivalent to Cᵢ above; the i index is used to emphasize the comparison to all other signatures, while the t index is used to relate the confidence value to the time in which it was obtained.) Of course, formulas described herein are intended as examples only and other or different formulas may be used.

In some embodiments, the prior waiting time estimation represents a difference between the entrance time stamp of the compared unique entrance signature and the exit time stamp of the compared unique exit signature. In some embodiments, this difference between two time stamps may be calculated as a function (e.g., percentage) of a length of the queue, such as, for example, the entire length of the queue. In such an embodiment where time stamps are generated at the queue entrance and at the queue exit, then the length of the queue may be considered 100% of the queue, and would not impact the prior waiting time estimation. In some embodiments, where an entire queue length cannot be properly accounted for, e.g., due to the image capture setup or image quality, etc., estimates based on portions of a queue can be aggregated or averaged across an entire length of a queue. In some embodiments, for example, when image capture devices are not available at both the queue entrance and the queue exit (and therefore time stamps are not available for both the queue entrance and the queue exit), but are available for two points representing a portion of the queue (e.g., a mid-point of the queue and either at the queue entrance or at the queue exit) an estimation may still be made, for example, by calculating the difference between the two time stamps (e.g., representing 50% of the total queue length) as a function of the entire queue length (e.g., multiplying by two (2) to reach 100%).

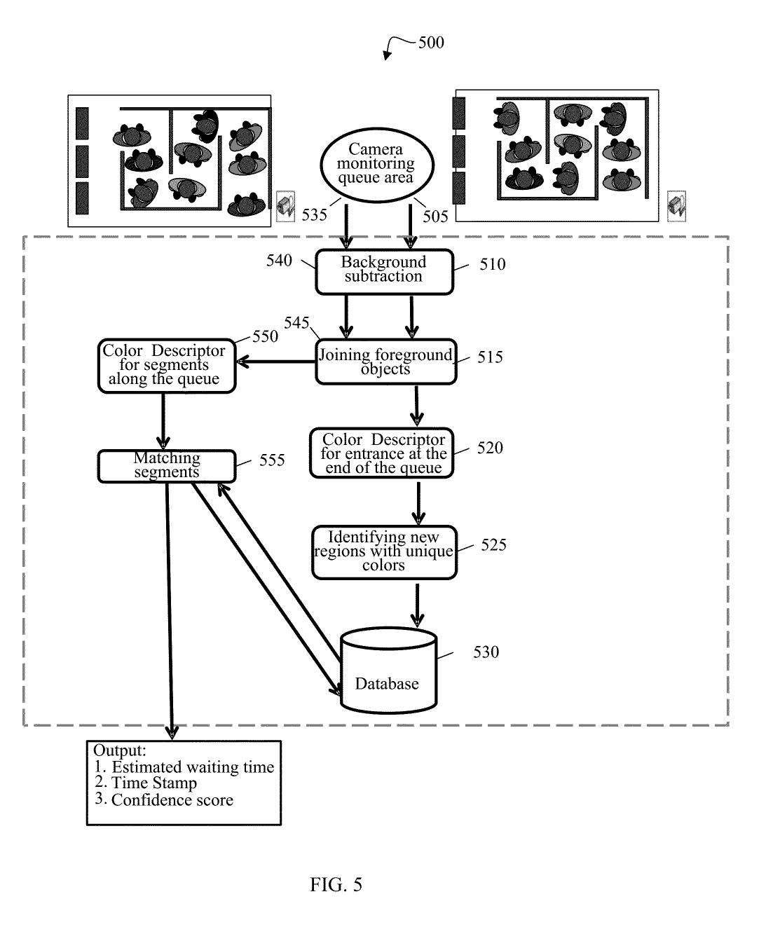

FIG. 5 shows a flow diagram of a method 500 of implementing unique color and/or texture tracking module 240 according to at least one embodiment of the invention. It is again noted that, in various embodiments, the UCT tracking module 240 may be implemented for calculating the prior waiting time in place of or in addition to the one or more person identifier modules 235. It is therefore not necessarily a mandatory system component for all embodiments, but its incorporation may increase the overall accuracy of the system as it may add more values for inclusion in an average prior waiting time estimation.

In some embodiments, where UCT tracking module 240 is to be implemented, the following conditions may be required regarding queue 100: (1) A top-view or nearly top-view image capture device installation, so that occlusions will be minimal; (2) the monitoring image capture devices 265 should monitor the queue area spanning from queue entrance 105 to queue exit 110 (rather than just monitoring the entrance and exit of the queue, as may be the case in some embodiments); and (3) a structured queue with a defined progress direction, where the chronological order of the people is almost always kept (for example, a snake line would satisfy this requirement).

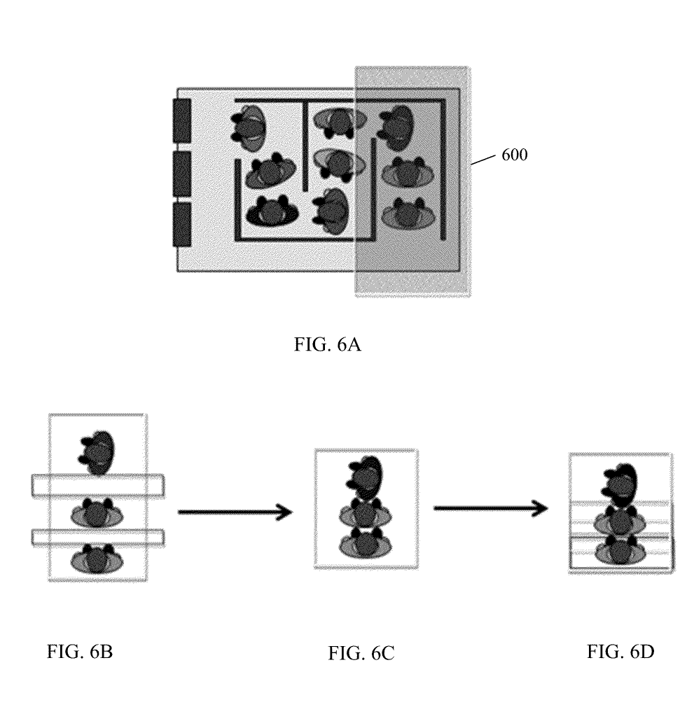

In some embodiments, method 500 includes at least two different processes which are typically implemented simultaneously or generally concurrently: searching for (identifying) new entering unique segments of a plurality of incomers, and tracking previously identified (e.g., existing) progressing unique segments relating to a plurality of progressing people as the plurality of progressing people progress along the queue. In some embodiments, when searching for new entering unique segments (e.g., unique segments of color and/or texture identified relating to one or more people entering the queue), the back-end area of the queue (e.g., the area just inside queue 100 when a person enters at queue entrance 105) may be constantly monitored to look for new unique segments. An example of such a back-end area is back-end area 600 outlined in the shaded area in FIG. 6A. Of course, the designated size (e.g., width, length, etc.) of the back-end area may constitute any number of sizes depending the configuration of queue 100 and/or on implementation of system 100.

In accordance with embodiments of the invention, method 500 therefore begins at step 505, when an image capture device 265 monitoring queue 100 streams image content (e.g., video) of queue 100 (and the people therein) to system server 210 in conventional manner. At step 510, system server 210, using server processor 215, which may be configured, for example, by executing one or more software modules 230, including, for example, UCT tracking module 240, detects, within back-end area 600, one or more foreground objects by first detecting irrelevant background, e.g., non-essential portions of an image, and then removing the detected background using background subtraction (see, for example, FIG. 6B). In some embodiments, existing background subtraction methods may be used. (For example, a method of background subtraction is described in: “Piccardi, M., 2004, “Background subtraction techniques: a review”. IEEE International Conference on Systems, Man and Cybernetics 4. pp. 3099-3104, incorporated herein by reference.) In some embodiments, whatever elements of an image that remain after background subtraction has been completed are presumed by the system to be the foreground objects, e.g., essential portions of an image.

At step 515, server processor 215, executing UCT tracking module 240, is configured to join all the foreground objects by, for example, removing large background areas along the queue proceeding direction using morphological operations (see, for example, FIG. 6C). For example, in some embodiments the input may be a binary image where zero (0) represents foreground pixels and one (1) represents background pixels. The goal is to identify large background areas. Therefore a first step may be as follows: small foreground pixels inside background areas are identified and turned into background pixels. This may be accomplished using morphological binary closing with a structural element with width and height, which are some fraction (for example 1/4) of a typical person's height and/or width as they appear in the FOV. The next step may be to identify the large background areas, especially along the queue length. The applied morphological operation may be, for example, a binary opening with a structural element of a width of almost the queue structure width and a height of some fraction of human typical height. The output may therefore be a mask image where the one (1) digit represents the pixels that belong to the big background regions. These “1” pixels will be avoided when dividing into segments. Yet, each segment can still include small groups of background pixels that will be disregarded when calculating the relevant descriptor. Of course, other methods of joining all the foreground objects may also be implemented, and the foregoing is meant as an example.

At step 520, server processor 215, executing UCT tracking module 240, is configured to define a color description for the segment in back-end area 600, e.g., at the back of the queue (see, for example, FIG. 6D). In some embodiments, this is accomplished by first dividing the queue into overlapping segments, for example, along the queue direction. In some embodiments, the width of the segment may be equivalent to the queue width. The segment height may be determined, for example, according to the typical human size (as viewed from above). Then, a color descriptor of each segment may be defined by using a histogram of 64 bins, for example, representing HSL (hue-saturation-lightness) and/or HSV (hue-saturation-value) color space calculated from the foreground pixels, by which dominant peaks of the histogram represent dominant colors in the segment.

At step 525, server processor 215, executing UCT tracking module 240, is configured to identify new regions (e.g., segments) with unique colors as unique entrance signatures representing unique segments. A segment is defined as unique if: (1) it has dominant colors; and (2) it has a different dominant color compared to the segments before it and after it (not including the adjacent segments which overlap it). At step 530, server processor 215, executing UCT tracking module 240, is configured to store, in database 255, one or more of unique entrance signature, the color description of the unique entrance segment, its unique bins, its position, size (several original segments may be joined) and the relevant entrance time stamp of the segment.

In accordance with embodiments of the invention, the steps for tracking existing unique segments begin simultaneously or generally concurrently with the steps for identifying new unique segments. Of course, it should be understood that the steps associated with tracking existing unique segments may begin at any point after a new unique segment has been identified in the queue. Furthermore, in some embodiments, this procedure is performed only if there is an existing unique segment already in database 255. In some embodiments, for each existing unique segment being searched for (e.g., tracked) in the queue, the relevant search area may stretch from the last location where the segment was observed until an area along the queue proceeding direction that depends on a maximal possible speed of people traveling in the queue. The maximal speed can be calculated, for example, by obtaining the minimal queue waiting time (from recent values). The maximal speed, then, may be calculated as the queue length divided by this minimal queue waiting time. Thus, the maximal range for searching the segment would be this speed multiplied by the time that passed since the segment was identified last.

An alternative embodiment, which may limit even more the search interval may be, for example, to use an optical flow method to determine the velocity of the people in the queue segment around the position where the tracked unique segment has been identified last. Thus, it is possible to calculate approximately the expected location of this segment in the queue. However, as the optical flow may not be accurate, to provide some confidence interval, an interval around this estimated location may be examined for the unique texture.] In other embodiments, predefined areas may be searched, such as, for example, an area along the queue proceeding direction equivalent to the size of the first identified section, the back-end area, or the entire area of the queue excluding a defined portion such as the back-end area. Of course, the entire queue, including the back-end area, may be searched as well.

At step 535, an image capture device 265 monitoring queue 100 streams image content (e.g., video) of queue 100 (and the people therein) to system server 210 in conventional manner to detect progress segments, e.g., unique entrance segments which have progressed along a length of the queue. At step 540, server processor 215, executing UCT tracking module 240, is configured to detect, within a defined search area of the queue, one or more foreground objects by first detecting irrelevant background, e.g., non-essential portions of an image, and then removing the detected background using background subtraction, as generally described regarding step 510. At step 545, server processor 215, executing UCT tracking module 240, is configured to join all the foreground objects by, for example, removing large background areas along the queue proceeding direction using morphological operations, as generally described regarding step 515. And at step 550, server processor 215, executing UCT tracking module 240, is configured to define a color description for the progress segment of the search area, as generally described regarding the back-end area 600 of step 520, and a progress signature is assigned to each detected progress segment.

At step 555, server processor 215, executing UCT tracking module 240, is configured to compare one or more unique entrance signatures with one or more unique progress signatures. In embodiments of the invention this may be accomplished by the server processor assigning a matching score between the existing unique segment stored in database 255 and one or more candidate segments detected in the search area. In some embodiments, only candidate segments that satisfy the following conditions may be examined: (1) candidate segments having dominant colors; and (2) candidate segments in which at least one of the dominant colors is identical to at least one of the unique colors of the existing unique segment. If a match is found (e.g., the matching score is higher than a matching threshold) and the location of the appropriate segment is far enough from queue exit 110, the new location is added to the database along with the matching score. Otherwise (e.g., if no match was found, no a match was found but the matching score did not meet the matching threshold, or the found segment is close to queue exit 110), the unique segment may be deleted from the database.

In some embodiments, if the segment was tracked along some significant distance (for example a ¼ queue length), a prior waiting time may be calculated as the total tracking time normalized by the portion of the tracking distance out of the total queue length. A confidence score may be determined by the length of the tracked distance and/or the matching scores along it. In some embodiments, the confidence score may be the average of all matching scores (e.g., each time the unique segment was matched) multiplied by the fraction of the queue length segment along which the color/texture was tracked and inversely normalized by the number of matches found for this segment. Furthermore, in some embodiments only matches above some defined score may be considered. The outputs, in this embodiment, of UCT tracking module 240 may include for example:

The prior waiting time estimation Uₜ;

The corresponding time stamp t; and

The confidence score Cₜ for the relevant matching score. (It should be noted that Cₜ is essentially equivalent to Cᵢ above; the i index is used to emphasize the comparison to all other signatures, while the t index is used to relate the confidence value to the time in which it was obtained.) Of course, formulas described herein are intended as examples only and other or different formulas may be used.

In some embodiments, the prior waiting time estimation represents a difference between an entrance time stamp of the compared unique entrance segment and a progress time stamp of the compared progress segment as a function of a length of the queue, such as, for example, the entire length of the queue. In some embodiments, where an entire queue length cannot be properly accounted for, e.g., due to the image capture setup or image quality, etc., estimates based on portions of a queue can be aggregated or averaged across an entire length of a queue.

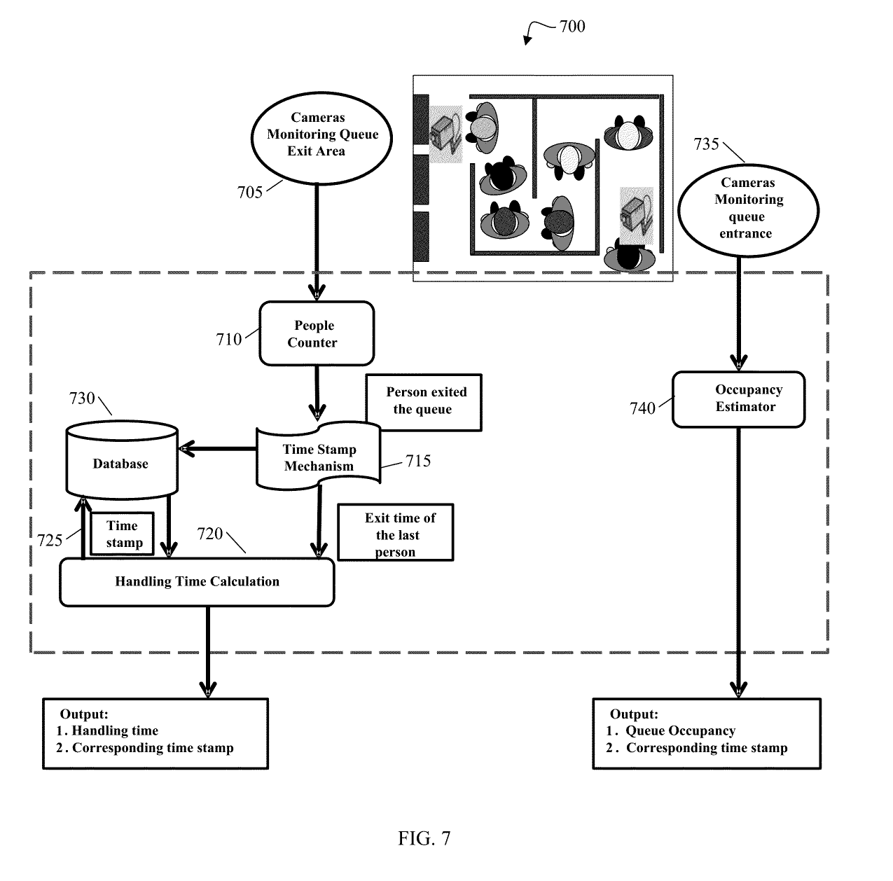

FIG. 7 shows a flow diagram of a method 700 of implementing person count module 245 according to at least one embodiment of the invention. In some embodiments, a goal of this model is to output a measure for queue occupancy which may be an essentiality in the expected waiting time estimation. Additionally, in embodiments where an image capture device 265 is incorporated at queue exit 110, a queue handling time may also be estimated, as described herein.

In accordance with embodiments of the invention, people count module 245 may be composed of two separate sub-systems. One sub-system is designated for estimating the handling time, and utilizes a people count component, for example, at queue exit 110, to calculate the queue handling time as the time difference between sequential people exiting the queue. A non-limiting example of a people counter component is presented in U.S. Pat. No. 7,787,656 (entitled “Method for Counting People Passing Through a Gate”), which is hereby incorporated by reference in its entirety. (Of course it will be understood that many examples of people counter components exist and therefore embodiments of the invention may use any number of different methods of counting people in a queue, depending, for example, on available resources, system implementation, and/or field conditions.) The people count component typically requires a defined queue exit area and an image capture device that monitors this area, preferably in top-view installation.

The second sub-system may estimate the occupancy in the queue area itself. The input may be a video or image stream from one or more image capture devices monitoring the queue area. For the purposes of this sub-system, the image capture devices are typically required to be installed in a top-view installation. In such an embodiment, the queue area occupancy may be considered proportional to the number of people in the queue. The occupancy estimator is a component that estimates the percentage of the occupied area in a queue out of the total queue area. The occupied area may be estimated, for example, as the number of foreground pixels out of the total area using a background subtraction method. The occupancy may be estimated, for example, constantly or periodically at identical time intervals.

In accordance with embodiments of the invention, the queue handling time estimation sub-system portion of method 500 begins at step 705, when an image capture device 265 monitoring at least queue exit 110 streams image content (e.g., video) of queue exit 110 to system server 210 in conventional manner. At step 710, system server 210, using server processor 215, which is configured by executing one or more software modules 230, including, for example, people count module 245, detects a person exiting queue 100 at queue exit 110. At step 715, server processor 215 is configured to extract the time stamp t associated with the person's exit, for example, by searching the image metadata for the time stamp. For example, in some embodiments the people count module, which may be a real time system, may output the number of exiting people (e.g., outgoers) each time it identifies an existing person (if it is only one person, this number is one). The database may then store the appropriate time stamps. At step 720, server processor 215 is configured to calculate the queue handling time Hₜ which in some embodiments may be calculated as the time difference between the time stamp t and the time stamp of the previous sequential exiting person. At step 725, the previous time stamp may be deleted from database 255, and at step 730, the newest time stamp may be saved in its place.

The outputs, in this embodiment, of the queue handling time estimation sub-system portion of people count module 245 are as follows:

Queue handling time Hₜ at time t; and

The corresponding time stamp t.

In embodiments when several people exit the queue at once, the system may output a queue handling time value of zero several times. (Formulas described herein are intended as examples only and other or different formulas may be used.)

In accordance with embodiments of the invention, the occupancy estimator sub-system portion of method 500 begins at step 735, when an image capture device 265 monitoring queue 100 streams image content (e.g., video) of queue 100 to system server 210 in conventional manner. At step 740, system server 210, using server processor 215, which is configured by executing one or more software modules 230, including, for example, people count module 245, may implement an occupancy estimator to calculate a queue occupancy for the queue. In some embodiments, queue occupancy may be an approximation of a number of people in the queue, while in other embodiments queue occupancy may be an actual number of people in the queue. In some embodiments, a queue occupancy approximation may be estimated by determining what percentage of the queue area is full relative to the entire area of the queue, and dividing the full area by an approximate size of a typical person. In some embodiments, a sub-system which detects the actual number of people in the queue (e.g., by detecting the number of heads, etc.) may be implemented. The queue occupancy may be determined at a constant time interval. The outputs, in embodiments where an occupancy estimator is used, of the queue occupancy sub-system portion of people count module 245 may be for example:

Queue occupancy percentage Oₜ at time t; and

The corresponding time t.

Alternatively, when an actual count of the number of people in the queue itself may be determined, the outputs of the queue occupancy sub-system portion of people count module 245 may be for example:

Nₜ number of people at time t; and

The corresponding time t. (Formulas described herein are intended as examples only and other or different formulas may be used.)

It should be noted that another alternative method of counting people in the queue may be implemented whereby a counter adds one for every person detected entering the queue, and subtracts one for every person detected exiting the queue. The outputs may or may not be exactly the same, depending on whether the system is enabled to compensate for any errors associated with people not being detected upon entry from and/or exit from the queue, and/or depending on the accuracy of the implemented people counter.

Returning now to FIG. 3, in accordance with embodiments of the invention, once the various outputs necessary for calculating the expected waiting time estimation have been outputted by the various modules as described herein, expected waiting time estimation module 250 may be executed by server processor 215, to determine the expected waiting time for example by:

The expected waiting time E_{T} of a person entering the queue at time T may be formulated as:

E_{T}=N_{T}*R̅_{T},

where:

N_{T}—is the number of people waiting in the queue at the time of entrance T.

R̅_{T}—is the recent average handling time for the prior period of time, until time T.

The recent average handling time R̅_{T} may be calculated or generated by server processor 215 based on the weighted averages of the following components, each of which is associated with one of the modules and uses the outputs of that module:

Wₜ—prior waiting times, the output of a person identifier module.

Uₜ—prior waiting times, the output of the color and/or texture tracking module.

Hₜ—queue handling times, the output of the people counter module.

For example, in some embodiments, a recent average handling time for the prior period of time may be generated based on at least the calculations of the one or more prior waiting time estimations, the queue handling time estimation, and the respective module weights, as described herein.

Of course, in other embodiments, other calculations or data may be used as an input to the recent average handling time, in addition or as an alternative. In some embodiments, each person identifier module may have one component associated with it. Although two person identifier modules are presented herein (one based on face recognition and the other based on suspect search signature), for clarity only one component associated with person identifier module is described.

R̅_{T}=α₂(T)H̅_̅{̅W̅}̅ _{_{T}}α₃(T)H̅_̅{̅U̅}̅ _{_{T}}α₁(T)H̅_{T}

Where α₁ (T), α₂ (T), α₃ (T) are the weights of each component. The formulas for each component may be for example:

Component related to people identifier module 235:

$${\overline{{H}_{W}}}_{T} = \frac{{\sum }_{i = 0}^{{M}_{1}} {β}_{{t}_{i}} {C}_{i} \frac{{W}_{{t}_{i}}}{{N}_{{t}_{i}}}}{{\sum }_{i = 0}^{{M}_{1}} {β}_{{t}_{i}} {C}_{i}} , \\ T - Δ t \leq {t}_{i} \leq T ,$$

where M₁ is the number of samples;

$$\frac{{W}_{{t}_{i}}}{{N}_{{t}_{i}}}$$

may be another way to estimate queue handling time, as it is the measured waiting time of a person that had entered the queue at time tᵢ divided by the number of people waiting in the queue at that time. In this average, for each value there are two weights: One (βₜ_{ᵢ}) representing the dependency on time, and another one Cᵢ representing the confidence obtained from the person identifier module.

Component related to unique color and/or texture tracking module 240:

$${\overline{{H}_{U}}}_{T} = \frac{{\sum }_{i = 0}^{{M}_{2}} {β}_{{t}_{i}} {C}_{i} \frac{{U}_{{t}_{i}}}{{N}_{{t}_{i}}}}{{\sum }_{i = 0}^{{M}_{2}} {β}_{{t}_{i}} {C}_{i}} , \\ T - Δ t \leq {t}_{i} \leq T$$

This component is similar to the previous component with the difference being that the waiting time is obtained from the UCT tracking module.

People counter module related component:

$${\overline{H}}_{T} = \frac{{\sum }_{i = 0}^{{M}_{3}} {β}_{{t}_{i}} {H}_{{t}_{i}}}{{\sum }_{i = 0}^{{M}_{3}} {β}_{{t}_{i}}} , \\ T - Δ t \leq {t}_{i} \leq T$$

H̅_{T} is the average of the queue handling time outputs Hₜ within the recent time interval Δt. The weights βₜ_{ᵢ} may be assigned according to the time stamp of the sample prioritizing recent values. In some embodiments, any formula that prioritizes recent times can be used to implement For example, 0.99^{T-t}, where T is the current time and t is the time at which the measurement was obtained, with the times being measured in minutes.

The weights α₁(T), α₂(T), α₃(T) may be written as:

$${δ}_{1} ( T ) = {\sum }_{i = 0}^{{M}_{1}} {β}_{{t}_{i}} {C}_{i} , \\ {δ}_{2} ( T ) = {\sum }_{i = 0}^{{M}_{2}} {β}_{{t}_{i}} {C}_{i} , \\ {δ}_{3} ( T ) = {\sum }_{i = 0}^{{M}_{3}} {β}_{{t}_{i}} , \\ T - Δ t \leq {t}_{i} \leq T$$

$${α}_{1 ( T )} = \frac{{δ}_{1} ( T ) {a}_{1}}{{a}_{1} {δ}_{1} ( T ) + {a}_{2} {δ}_{2} ( T ) + {a}_{3} {δ}_{3} ( T )} , \\ {α}_{2 ( T )} = \frac{{δ}_{2} ( T ) {a}_{2}}{{a}_{1} {δ}_{1} ( T ) + {a}_{2} {δ}_{2} ( T ) + {a}_{3} {δ}_{3} ( T )} , \\ {α}_{3 ( T )} = \frac{{δ}_{3} ( T ) {a}_{3}}{{a}_{1} {δ}_{1} ( T ) + {a}_{2} {δ}_{2} ( T ) + {a}_{3} {δ}_{3} ( T )} , \\ T - Δ t \leq {t}_{i} \leq T$$

Hence,

$${\overline{R}}_{T} = \frac{1}{δ ( T )} ( {a}_{1} {δ}_{1} ( T ) {\overline{{H}_{W}}}_{T} + {a}_{2} {δ}_{2} ( T ) {\overline{{H}_{U}}}_{T} + {a}_{3} {δ}_{3} ( T ) {\overline{H}}_{T} )$$

where:

δ(T)=a₁δ₁(T)+a₂δ₂(T)+a₃δ₃(T)

In some embodiments, a module weight may be assigned to each of the one or more prior waiting time estimations and/or to the handling time estimation based on, for example, a historical module accuracy for a previous period of time T. In some embodiments, estimations which have historically proven to be more accurate at predicting an estimated waiting time (e.g., have a high historical module accuracy, for example, compared to some benchmark or threshold) may receive higher module weights, and vice versa. As such, constants a₁, a₂, a₃ may represent, for example, the weight of each component according to the confidence in its accuracy. A method for finding these values is presented herein.

The normalization values δ₁(T), δ₂(T), δ₃(T) incorporate the dependency on the number of averaged values and their confidence. For example, a higher weight should be assigned to the second component when a person identifier module outputs many values with high confidence compared to when it generates few values with low confidence.

Replacing α₁(T), α₂(T), α₃(T) with their expression in formula, results in the following:

$${\overline{R}}_{T} = \frac{1}{{a}_{1} {δ}_{1} ( T ) + {a}_{2} {δ}_{2} ( T ) + {a}_{3} {δ}_{3} ( T )} * ( {a}_{1} {\sum }_{i = 0}^{{M}_{1}} {β}_{{t}_{i}} {C}_{i} \frac{{W}_{{t}_{i}}}{{N}_{{t}_{i}}} + {a}_{2} {\sum }_{i = 0}^{{M}_{2}} {β}_{{t}_{i}} {C}_{i} \frac{{U}_{{t}_{i}}}{{N}_{{t}_{i}}} + {a}_{3} {\sum }_{i = 0}^{{M}_{3}} {β}_{{t}_{i}} {H}_{{t}_{i}} ) , \\ T - Δ t \leq {t}_{i} \leq T .$$

The expected waiting time T may be, for example:

E_{T}=N_{T}*R̅_{T}

In case of measuring the occupancy in the queue rather than the number of people itself, the following formulas are developed.

Using queue occupancy instead of number of people:

In such case the number of people is related to queue occupancy in a linear relationship:

W_{T}=αO_{T}

Where α is the occupancy percentage corresponding to one person.

Therefore:

$$\begin{matrix}{W}_{T} = {N}_{T } * {\overline{R}}_{T} \\ = α {O}_{T} * {\overline{R}}_{T} \\ = \frac{{O}_{T}}{{a}_{1} {δ}_{1} ( T ) + {a}_{2} {δ}_{2} ( T ) + {a}_{3} {δ}_{3} ( T )} \\ ( {a}_{1} {\sum }_{i = 0}^{{M}_{1}} {β}_{{t}_{i}} {C}_{i} \frac{{W}_{{t}_{i}}}{{O}_{{t}_{i}}} + {a}_{2} {\sum }_{i = 0}^{{M}_{2}} {β}_{{t}_{i}} {C}_{i} \frac{{U}_{{t}_{i}}}{{O}_{{t}_{i}}} + α {a}_{3} {\sum }_{i = 0}^{{M}_{3}} {β}_{{t}_{i}} {H}_{{t}_{i}} ) ,\end{matrix}$$

$$T - Δ t \leq {t}_{i} \leq T$$

Calculating the weights of the components aᵢ:

The module weights of the module-related components may be updated at a much slower rate than the estimations of the waiting times. As the weights essentially represent the accuracy of each module in the specific scene, they are valid as long as the scene does not change. Thus, their values may be obtained periodically (e.g., once in a while) rather than be calculated continuously. In addition, in some embodiments dependency on different times of the day may also be incorporated. Thus, for example, if the illumination in the scene varies over the day, embodiments of the invention may calculate the suitable weights for the different hours and use them accordingly. The goal is to assign higher weights to components that have been historically proven to successfully predict the waiting times. One method of ascertaining this may be solving a sequential least squares problem where the dependent variable is the real waiting time.

In some embodiments, ground truth values of real waiting times may be used as the dependent variables. If the real waiting times are not available, the output waiting times from person identifier modules with high confidence scores will serve as the dependent variables. These values are indeed related to the relevant component associated with the same person identifier module. But it will not necessarily prioritize this component as the component includes another dependency on the number of people and its waiting time values are taken from past times relative to the waiting time value they are supposed to predict.

The following sequential least square problem with constraints may be solved:

$${min}_{X ∈ S} {‖ AX - b ‖}_{2}^{2}$$

$$S = \{ x \vert {‖ CX - d ‖}_{2} = min \}$$

Where:

$$b = ( \begin{matrix}{W}_{{t}_{1}} \\ {W}_{{t}_{2}} \\ ⋮ \\ {W}_{{t}_{N}}\end{matrix} ) , \\ A = ( \begin{matrix}{δ}_{1} ( {t}_{1} ) {\overline{{H}_{W}}}_{{t}_{1}} & {δ}_{2} ( {t}_{1} ) {\overline{{H}_{U}}}_{{t}_{1}} & {δ}_{3} ( {t}_{1} ) {\overline{H}}_{{t}_{1}} \\ {δ}_{1} ( {t}_{2} ) {\overline{{H}_{W}}}_{{t}_{2}} & {δ}_{2} ( {t}_{2} ) {\overline{{H}_{U}}}_{{t}_{2}} & {δ}_{3} ( {t}_{2} ) {\overline{H}}_{{t}_{2}} \\ ⋮ & ⋮ & ⋮ \\ {δ}_{1} ( {t}_{N} ) {\overline{{H}_{W}}}_{{t}_{N}} & {δ}_{2} ( {t}_{N} ) {\overline{{H}_{U}}}_{{t}_{N}} & {δ}_{3} ( {t}_{N} ) {\overline{H}}_{{t}_{N}}\end{matrix} ) , \\ X = ( \begin{matrix}{a}_{1} \\ {a}_{2} \\ {a}_{3}\end{matrix} ) , \\ C = ( \begin{matrix}{δ}_{1} ( {t}_{1} ) & {δ}_{2} ( {t}_{1} ) & {δ}_{3} ( {t}_{1} ) \\ {δ}_{1} ( {t}_{2} ) & {δ}_{2} ( {t}_{2} ) & {δ}_{3} ( {t}_{2} ) \\ ⋮ & ⋮ & ⋮ \\ {δ}_{1} ( {t}_{N} ) & {δ}_{2} ( {t}_{N} ) & {δ}_{3} ( {t}_{N} )\end{matrix} ) , \\ d = ( \begin{matrix}1 \\ 1 \\ ⋮ \\ 1\end{matrix} )$$

In some embodiments, a decay weight may be assigned to one or more of the prior waiting time estimations, the queue handling time estimation, and/or the queue occupancy, based on, for example, a decaying time scale, whereby recent calculations are assigned lower decay weights and older-in-time calculations are assigned higher decay weights. Such decay weight may be in addition to or in place of other weights employed in the methods described herein.

In some embodiments, α₁, α₂, α₃ may be assigned with values inversely proportional to estimation errors of the appropriate modules. For example, consider E₁, E₂, E₃, to be the prediction errors associated with the person identifier module component, UCT module component, and people count module component. The appropriate weights may be calculated, for example, as:

$${a}_{1} = \frac{\frac{1}{{E}_{1}}}{\frac{1}{{E}_{1}} + \frac{1}{{E}_{2}} + \frac{1}{{E}_{3}}} , \\ {a}_{2} = \frac{\frac{1}{{E}_{2}}}{\frac{1}{{E}_{1}} + \frac{1}{{E}_{2}} + \frac{1}{{E}_{3}}} , \\ {a}_{3} = \frac{\frac{1}{{E}_{3}}}{\frac{1}{{E}_{1}} + \frac{1}{{E}_{2}} + \frac{1}{{E}_{3}}}$$

E₁, for example, will be calculated as E₁=μb−H₁ ∥₂², where:

$$b = ( \begin{matrix}{W}_{{t}_{1}} \\ {W}_{{t}_{2}} \\ ⋮ \\ {W}_{{t}_{N}}\end{matrix} ) , \\ {H}_{1} = ( \begin{matrix}{N}_{{t}_{1}} {\overline{{H}_{W}}}_{{t}_{1}} \\ {N}_{{t}_{2}} {\overline{{H}_{W}}}_{{t}_{2}} \\ ⋮ \\ {N}_{{t}_{N}} {\overline{{H}_{W}}}_{{t}_{N}}\end{matrix} )$$

This method may not necessarily produce the same results as solving the sequential least square problem as described herein, yet its calculation is much easier.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

What is claimed is:

1. A method for estimating an expected waiting time for a person entering a queue, the method performed on a computer having a processor, memory, and one or more code modules stored in the memory and executing in the processor, the method comprising:
receiving, at the processor, image data captured from at least one image capture device during a period of time prior to the person entering the queue;
calculating, by the processor, based on the image data, one or more prior waiting time estimations, a queue handling time estimation, and a queue occupancy;
wherein a prior waiting time estimation is an estimation of the time a prior outgoer of the queue waited in the queue; and
wherein a queue handling time estimation is an estimation of an average handling time for an outgoer of the queue;
assigning, by the processor, a module weight to each of the one or more prior waiting time estimations and to the queue handling time estimation;
generating, by the processor, based on at least the calculations of the one or more prior waiting time estimations, the queue handling time estimation, and the respective module weights, a recent average handling time for the prior period of time; and
determining, by the processor, the expected waiting time based on the recent average handling time and the queue occupancy.

2. The method as in claim 1, further comprising:
generating, by the processor, for each prior waiting time estimation, an associated confidence score.

3. The method as in claim 1, wherein calculating the one or more prior waiting time estimations comprises:
identifying, by the processor, based on the image data, one or more incomers as the one or more incomers enter the queue, and one or more outgoers as the one or more outgoers exit the queue;
generating, by the processor, for each identified incomer, a unique entrance signature and an entrance time stamp, and for each identified outgoer, a unique exit signature and an exit time stamp;
comparing, by the processor, one or more unique exit signatures with one or more unique entrance signatures; and
based on the signature comparing step, outputting, by the processor, a prior waiting time estimation, wherein the prior waiting time estimation represents a difference between the entrance time stamp of the compared unique entrance signature and the exit time stamp of the compared unique exit signature.

4. The method as in claim 3, wherein:
each signature comparison is assigned a similarity score representing a likelihood of the one or more compared unique exit signatures and the one or more compared unique entrance signatures having each been generated from the same person; and
wherein outputting the prior waiting time estimation is based on a highest assigned similarity score among a plurality of signature comparisons.

5. The method as in claim 1, wherein calculating the one or more prior waiting time estimations comprises:
identifying, by the processor, based on the image data, one or more entering unique segments relating to a plurality of incomers as the plurality of incomers enter the queue, and one or more progressing unique segments relating to a plurality of progressing people as the plurality of progressing people progress along the queue;
generating, by the processor, for each identified entering unique segment, a unique entrance signature and an entrance time stamp, and for each identified progressing unique segment, a unique progress signature and a progress time stamp;
comparing, by the processor, one or more unique entrance signatures with one or more unique progress signatures; and
based on the signature comparing step, outputting, by the processor, a prior waiting time estimation, wherein the prior waiting time estimation represents a difference between the entrance time stamp of the compared unique entrance signature and the exit time stamp of the compared unique exit signature as a function of a length of the queue.

6. The method as in claim 5, wherein:
each signature comparison is assigned a similarity score representing a likelihood of the one or more compared unique entrance signatures and the one or more compared unique progress signatures having each been generated from the one or more people; and
wherein outputting the prior waiting time estimation is based on a highest assigned similarity score among a plurality of signature comparisons.

7. The method as in claim 1, wherein the handling time estimation comprises a difference in time between a first identified outgoer of the queue and a second identified outgoer of the queue, as a function of a number of available queue handling points at an exit of the queue.

8. The method as in claim 1, wherein a module weight is assigned to each of the one or more prior waiting time estimations and to the handling time estimation based on a historical module accuracy for a previous period of time.

9. The method as in claim 1, wherein generating the recent average handling time further comprises:
assigning a decay weight to one or more of the one or more prior waiting time estimations, the queue handling time estimation, and the queue occupancy, based on a decaying time scale, wherein recent calculations are assigned lower decay weights and older-in-time calculations are assigned higher decay weights.

10. The method as in claim 1, wherein queue occupancy comprises at least one of an approximation of a number of people in the queue and an actual number of people in the queue.

11. A system for estimating an expected waiting time for a person entering a queue, comprising:
a computer having a processor and memory;
one or more code modules that are stored in the memory and that are executable in the processor, and which, when executed, configure the processor to:
receive image data captured from at least one image capture device during a period of time prior to the person entering the queue;
calculate, based on the image data, one or more prior waiting time estimations, a queue handling time estimation, and a queue occupancy;
wherein a prior waiting time estimation is an estimation of the time a prior outgoer of the queue waited in the queue; and
wherein a queue handling time estimation is an estimation of an average handling time for an outgoer of the queue;
assign a module weight to each of the one or more prior waiting time estimations and to the queue handling time estimation;
generate, based on at least the calculations of the one or more prior waiting time estimations, the queue handling time estimation, and the respective module weights, a recent average handling time for the prior period of time; and
determine the expected waiting time based on the recent average handling time and the queue occupancy.

12. The system as in claim 11, further configured to:
generate, for each prior waiting time estimation, an associated confidence score.

13. The system as in claim 11, further configured to:
identify, based on the image data, one or more incomers as the one or more incomers enter the queue, and one or more outgoers as the one or more outgoers exit the queue;
generate, for each identified incomer, a unique entrance signature and an entrance time stamp, and for each identified outgoer, a unique exit signature and an exit time stamp;
compare one or more unique exit signatures with one or more unique entrance signatures; and
based on the signature comparing step, output a prior waiting time estimation, wherein the prior waiting time estimation represents a difference between the entrance time stamp of the compared unique entrance signature and the exit time stamp of the compared unique exit signature.

14. The system as in claim 13, wherein:
each signature comparison is assigned a similarity score representing a likelihood of the one or more compared unique exit signatures and the one or more compared unique entrance signatures having each been generated from the same person; and
wherein outputting the prior waiting time estimation is based on a highest assigned similarity score among a plurality of signature comparisons.

15. The system as in claim 11, further configured to:
Identify, based on the image data, one or more entering unique segments relating to a plurality of incomers as the plurality of incomers enter the queue, and one or more progressing unique segments relating to a plurality of progressing people as the plurality of progressing people progress along the queue;
Generate, for each identified entering unique segment, a unique entrance signature and an entrance time stamp, and for each identified progressing unique segment, a unique progress signature and a progress time stamp;
compare one or more unique entrance signatures with one or more unique progress signatures; and
based on the signature comparing step, output a prior waiting time estimation, wherein the prior waiting time estimation represents a difference between the entrance time stamp of the compared unique entrance signature and the exit time stamp of the compared unique exit signature as a function of a length of the queue.

16. The system as in claim 15, wherein:
each signature comparison is assigned a similarity score representing a likelihood of the one or more compared unique entrance signatures and the one or more compared unique progress signatures having each been generated from the one or more people; and
wherein outputting the prior waiting time estimation is based on a highest assigned similarity score among a plurality of signature comparisons.

17. The system as in claim 11, wherein the handling time estimation comprises a difference in time between a first identified outgoer of the queue and a second identified outgoer of the queue, as a function of a number of available queue handling points at an exit of the queue.

18. The system as in claim 11, wherein a module weight is assigned to each of the one or more prior waiting time estimations and to the handling time estimation based on a historical module accuracy for a previous period of time.

19. The system as in claim 11, further configured to:
assign a decay weight to one or more of the one or more prior waiting time estimations, the queue handling time estimation, and the queue occupancy, based on a decaying time scale, wherein recent calculations are assigned lower decay weights and older-in-time calculations are assigned higher decay weights.

20. The system as in claim 11, wherein queue occupancy comprises at least one of an approximation of a number of people in the queue and an actual number of people in the queue.
